(19) United States
(12) Patent Application Publication
(10) Pub. No.: US 2009/0225043 A1
(43) Pub. Date: Sep. 10, 2009

(54) Touch Feedback With Hover

(75) Inventor: Douglas K. Rosener, Santa Cruz, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC., Santa Cruz, CA (US)

(21) Appl. No.: 12/043,084

(22) Filed: Mar. 5, 2008

(51) Int. Cl. G06F 3/041

(52) U.S. Cl. 345/173

(57) ABSTRACT

An electronic device includes one or more touch sensors. Upon detection that a user's finger or hand is brought within close proximity to a touch sensor, the electronic devices provides a user feedback to the user. The user feedback may be specifically associated with a touch sensor, thereby allowing the user to distinguish between different touch sensors prior to contacting them.

### BACKGROUND OF THE INVENTION

Today's electronic devices often utilize a variety of techniques to interface with users. For example, common electronic devices such as personal computers, personal digital assistants, cellular telephones, and headsets often utilize mechanical buttons which are depressed by the user. In addition to mechanical buttons and switches, electronic devices also use touch sensors such as capacitive sensing systems that operate based on charge, current or voltage. These touch sensors can be used in varying applications such as scroll strips, touch pads, and buttons.

Users generally operate devices with touch sensors by placing the user's finger on or near the sensing region of a desired touch sensor disposed on the electronic device housing. The user's finger on the sensing region results in a capacitive effect upon a signal applied to the sensing region. This capacitive effect is detected by the electronic device, and correlated to positional information, motion information, or other similar information of the user's finger relative to the touch sensor sensing region. This positional information or motion information is then processed to determine a user desired input action, such as a select, scroll, or move action.

The use of touch sense controls eliminate the need for mechanical controls such as mechanical buttons. However, mechanical controls offer certain advantages. For example, with mechanical buttons the user can lightly feel for texture and shape to deduce button location and function without visually identifying the button. This is particularly useful for devices that may need to be operated out of user view, such as with headsets.

Where a device uses touch sensor controls, the ability of the user to identify a desired touch sensor non-visually is limited. If the user contacts the touch sensor in an attempt to identify it, the touch sensor processes the contact as a potential user input action. In many cases, users are worried or cautious about operating a control by accident, resulting in trepidation of using touch sense controls. Some electronic devices provide some form of feedback in the form of texture, haptics (including force/motion feedback), or sound following user contact of the touch sensor. However, such feedback occurs after the touch sense control has been activated. The user may still choose the wrong touch sensor control. In the prior art, to avoid false triggers, the user interface is forced to require hold-times or behaviors such as double-taps to ensure the touch-sense control is really desired. However, these solutions complicate the user interface interaction, resulting in decreased ease of use or effectiveness.

As a result, there is a need for improved methods and apparatuses for electronic devices using touch sensors.

### BRIEF DESCRIPTION OF THE DRAWINGS

The present invention will be readily understood by the following detailed description in conjunction with the accompanying drawings, wherein like reference numerals designate like structural elements.

FIG. 1 schematically illustrates an electronic device with user feedback components.

FIG. 2 illustrates a simplified block diagram of the components of a headset illustrating the user feedback components shown in FIG. 1 in an example.

FIG. 3 schematically illustrates a headset touch sensor input user interface with proximity detection.

FIG. 4 is a flowchart illustrating processing of a user interface interaction in an example.

FIG. 5 is a flowchart illustrating example processing of a user interface interaction in a further example.

FIG. 6 is an electronic device in a further example.

### DESCRIPTION OF SPECIFIC EMBODIMENTS

Methods and apparatuses for an electronic device user interface are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

This invention relates generally to the field of electronic devices with touch-sense controls. In one example, the methods and systems described herein eliminate the requirement for hold-times or complicated behaviors on touch sense controls by sensing proximity, and then giving the user feedback. In one example, the system includes a touch sense controller with proximity capability connected to or implemented on a processor, one or more touch sense controls, a feedback element, such as a haptics motor, audio path and speaker, and lights, and appropriate software to implement the application operating the controller and the processor.

In a telecommunications headset example application, a user would hover over a headset by bringing his finger near the headset without contact and feel a vibration pattern near the touch-sense call button. Moving up to the touch sense volume-up button, the user would feel a different vibration. Since the actual touch has not occurred, this is equivalent to the user feeling the mechanical buttons without pressing/executing them, allowing the user to explore touch controls with the user's fingers without committing to them.

Although particulary useful for devices that cannot be seen while operated, the invention may also be used for other electronic devices. Even when in view during operation, it may be advantageous for the user to receive feedback such as through a visual indicator when the user is in close proximity to a sensor. This may allow the user to more quickly identify a desired touch sensor or allow the user to identify a desired touch sensor without committing to action.

In one example, a headset includes a microphone, a speaker, and a proximity sensing touch sensor. The touch sensor detects a close proximity status whereby a user's finger is within a certain proximity to the proximity sensing touch sensor and detects a subsequent touch status whereby the user's finger is in contact with the proximity sensing touch sensor. The headset includes a user feedback mechanism associated with the proximity sensing touch sensor, and a processor. The processor responsively processes a close proximity status detection by outputting a feedback to the user with the user feedback mechanism and processes the subsequent touch status by performing a desired user action.

In one example, an apparatus includes a plurality of proximity sensing touch sensors for detecting a plurality of close proximity statuses, where each close proximity status detected is associated with a particular proximity sensing touch sensor. The apparatus includes a plurality of user feedback mechanisms, where each user feedback mechanism is associated with a particular proximity sensing touch sensor. The apparatus further includes a processor, where the processor responsively processes a detected close proximity status by outputting a feedback to the user with the particular user feedback mechanism associated with the particular proximity sensing touch sensor.

In one example, an apparatus includes a plurality of proximity sensing touch sensors for detecting a plurality of close proximity statuses, where each close proximity status detected is associated with a particular proximity sensing touch sensor. The apparatus includes a plurality of non-visual user feedback mechanisms, where each non-visual user feedback mechanism is associated with a particular proximity sensing touch sensor. The apparatus further includes a processor, where the processor responsively processes a detected close proximity status by outputting a feedback to the user with the particular non-visual user feedback mechanism associated with the particular proximity sensing touch sensor, thereby enabling the user to determine non-visually which proximity sensing touch sensor the user is in close proximity to.

In one example, a method for interfacing with an electronic device includes providing a plurality of proximity sensing touch sensors on an electronic device, providing a plurality of user feedback mechanisms for the electronic device, and associating a particular user feedback mechanism with a particular proximity sensing touch sensor. The method further includes detecting a close proximity status to a particular proximity sensing touch sensor, and outputting the particular user feedback mechanism associated with the particular proximity sensing touch sensor for which a close proximity status is detected.

In one example, an apparatus includes a plurality of proximity sensing means such as capacitive sensors for detecting a plurality of close proximity statuses, where each close proximity status detected is associated with a particular proximity sensing means. The apparatus includes a plurality of user feedback means such as a haptics vibrate motor or audio speaker output for outputting a user feedback, where each user feedback means is associated with a particular proximity sensing means. The apparatus further includes a processing means such as a processor for outputting a feedback to the user with the particular user feedback means associated with the particular proximity sensing means for which a close proximity status is detected.

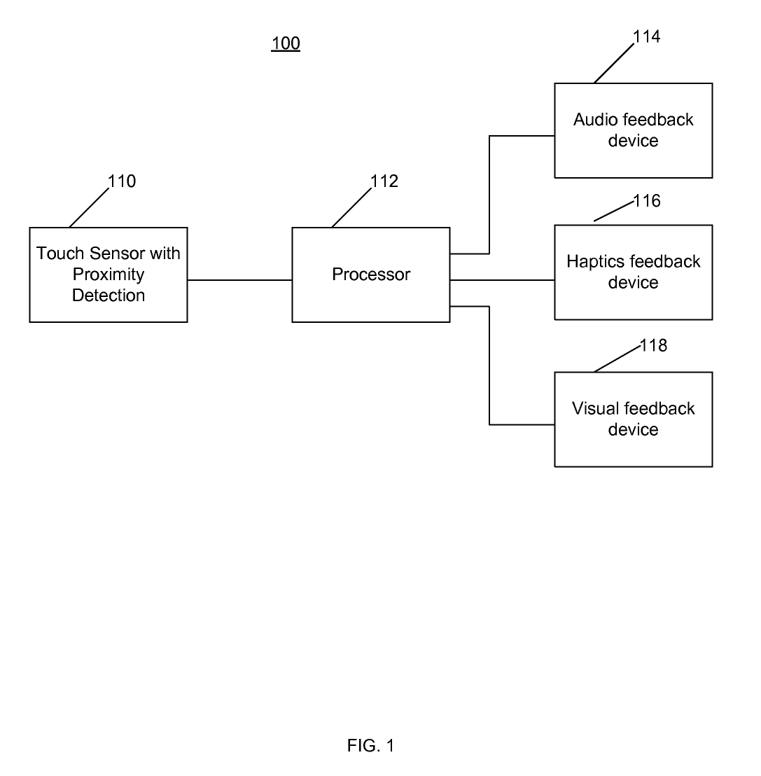

FIG. 1 schematically illustrates an electronic device 100 with user feedback components. The electronic device includes at least one touch sensor 110 with proximity detection, a processor 112, and user feedback components including audio feedback device 114, haptics feedback device 116, and visual feedback device 118. For example, audio feedback device 114 may be a loudspeaker, haptics feedback device 116 may be a vibrate motor, and visual feedback device 118 may be a light emitting diode. As described herein, the type and number of user feedback mechanisms may be varied. The general operation of electronic device 100 is that touch sensor 110 monitors whether a user finger or hand is brought within a predetermined proximity to touch sensor 110.

Upon detection that a user finger or hand is within the predetermined proximity, processor 112 executing firmware or software outputs a user feedback using audio feedback device 114, haptics feedback device 116, or visual feedback device 118. Audio feedback device 114 provides an audio output and haptics feedback device 116 provides a tactile sensation output such as vibration. In this manner, the user is informed that his or her finger is in proximity to touch sensor 110, and the user can select to either perform or not perform a desired action by physically contacting touch sensor 110. Electronic device 100 may be any device using a touch sensor input. Common electronic devices using touch sensors may for example be, without limitation, headsets, personal computers, personal digital assistants, digital music players, or cellular telephones.

The electronic device 100 may include more than one touch sensor 110, and a particular user feedback mechanism may be associated with a particular touch sensor. Upon detection that a user finger or hand is in proximity to a particular touch sensor, the user receives the particular feedback associated with that particular touch sensor. In this manner, the user can locate a desired touch sensor by the feedback provided when

User feedback may be categorized as either visual feedback or non-visual feedback. Both audio feedback device 114 and haptics feedback device 116 operate as non-visual interfaces, where communication with the user does not rely on user vision. Visual feedback device 118 serves as a visual user interface. Non-visual interfaces are particularly useful for devices that are operated out of visual sight of the user, such as a headset currently in a worn state. A particular user feedback device may be operated in a manner to provide a plurality of user feedbacks. For example, haptics feedback device 116 may be operated to provide different vibrate patterns, where each vibrate pattern is associated with a different touch sensor. Similarly, audio feedback device 114 may output a plurality of distinct audio tones or audio patterns, where each audio tone or pattern is associated with a different touch sensor.

In a further example, the user feedback mechanisms may be implemented on a device remote from the device with the touch sensors. In such an example, the signals output from the touch sensors are transmitted through either a wired or wireless interface to the device with the user feedback mechanisms.

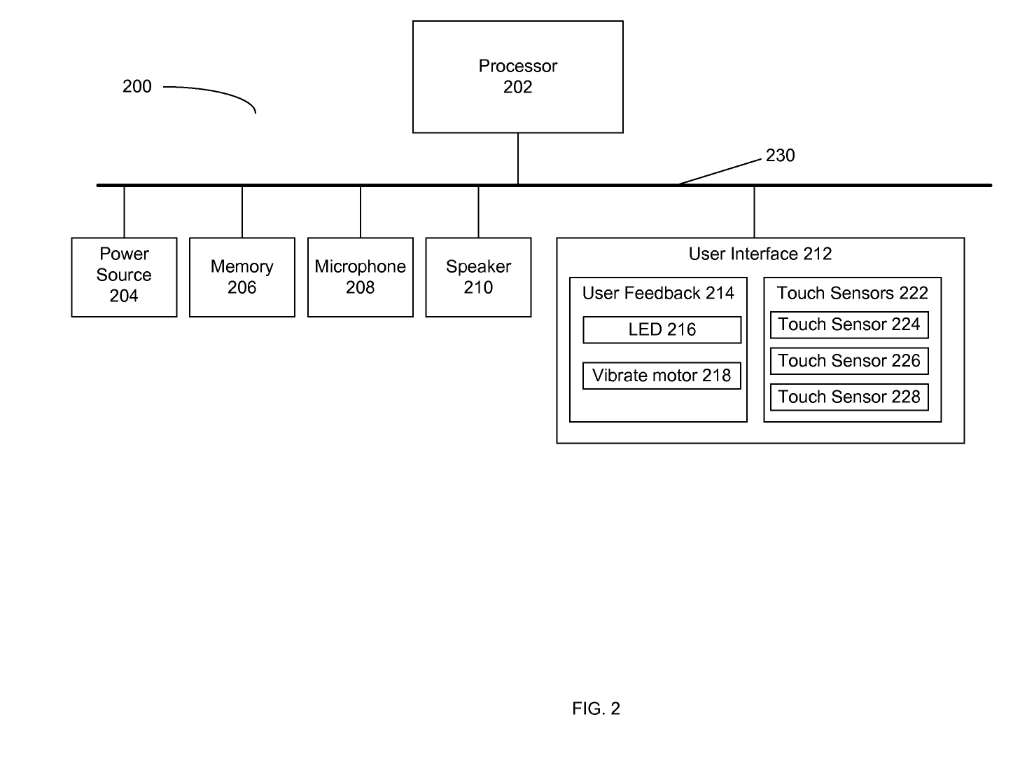

FIG. 2 illustrates a simplified block diagram of the components of a headset example application of an electronic device shown in FIG. 1. Recent developments in the telecommunications industries have produced telecommunications headsets with increased capabilities. As a result, the complexity of interacting with these devices has increased. For example, headsets may control navigation through menus or files. However, headset form factors do not lend themselves well to traditional user interface technologies like keypads and displays which are suited for complex user man-machine interface interactions. For example, the available space on the headset housing is limited and visual indicators have limited use while the headset is worn. This limited user interface makes access to more complex features and capabilities difficult and non-intuitive, particularly when the headset is being worn. Thus, a headset with user feedback responsive to proximity detection is particularly advantageous as it allows non-visual identification of headset touch sensors which may be of limited size and separation on the headset housing.

The headset 200 includes a processor 202 operably coupled via a bus 230 to a memory 206, a microphone 208, power source 204, speaker 210, and user interface 212. User interface 212 includes one or more touch sensors 222 and one or more user feedback mechanisms 214. In the example shown in FIG. 2, touch sensors 222 include three touch sensors: touch sensor 224, touch sensor 226, and touch sensor 228. However, one of ordinary skill in the art will recognize that a fewer or greater number of touch sensors may be used. In the example shown in FIG. 2, headset 200 includes a light emitting diode (LED) 216 operating as a light feedback device, and a vibrate motor 218 operating as a haptics feedback device. In addition, speaker 210 operating as an audio feedback device may be used to provide user feedback. Light emitting diode 216 provides light feedback to the user when the headset is not being worn, such as where the headset 200 is lying on a table. In a further example, the headset may include a head display or heads-up display whereby light feedback is provided to the user via the display or heads-up display.

In one example, touch sensors 222 are capacitive sensors. For example, touch sensors 222 may be charge transfer sensing capacitance sensors for proximity detection. Touch sensors 222 may respond to voltage, current, or charge to detect position or proximity. The touch sensors 222 are arranged to output information to processor 202, including whether the sensors are touched and a signal indicating the proximity of a user's finger to the sensors.

Memory 206 stores firmware/software executable by processor 202 to operate touch sensors 222 and process proximity data, physical contact data, and user inputs received from touch sensors 222. Memory 206 may include a variety of memories, and in one example includes SDRAM, ROM, flash memory, or a combination thereof. Memory 206 may further include separate memory structures or a single integrated memory structure. In one example, memory 206 may be used to store user preferences associated with preferred user feedback mechanisms.

Processor 202, using executable code and applications stored in memory, performs the necessary functions associated with headset operation described herein. Processor 202 allows for processing data, in particular managing data between touch sensors 222 and user feedback mechanisms 214. In one example, processor 202 is a high performance, highly integrated, and highly flexible system-on-chip (SOC), including signal processing functionality. Processor 202 may include a variety of processors (e.g., digital signal processors), with conventional CPUs being applicable.

Touch sensors 222 may detect whether the user is “tapping” or “double tapping” the touch sensors 222, i.e., quickly placing his finger tip on touch sensors 222 and then removing it. Touch sensors 222 may be a linear scroll strip, the forward or backward motion along which is translated to a pre-defined user input, such as scrolling through a menu or volume increase or decrease. User tapping or double tapping is translated, for example, to a user selected command. Touch sensors 222 may also take the form of user input buttons, scroll rings, and touch pad-type sensors. The touch pad-type sensor can be used to provide input information about the position or motion of the user's finger along either a single axis or two axes.

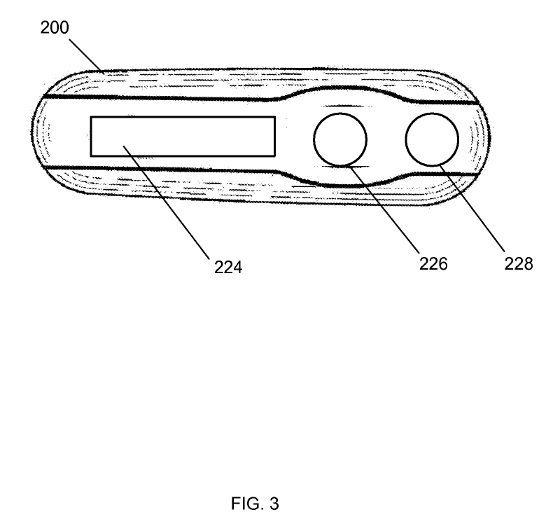

FIG. 3 illustrates a top view of a headset touch sensor input user interface with proximity detection in one example. The housing body of a headset 200 includes a touch sensor 224, touch sensor 226, and touch sensor 228. Touch sensors 224, 226, and 228 may be configured to perform a variety of headset user interface actions associated with headset control operations. Such headset control operations may include volume control, power control, call answer, call terminate, item select, next item select, and previous item select. Each touch sensor 224, 226, and 228 includes circuitry to output a proximity signal indicating the proximity of a user's hand or finger to the touch sensor, and a touch status indicating whether or not the sensor has been touched. Where the touch sensor is a linear strip, such as touch sensor 224, the touch sensor also indicates a position signal that indicates where along the touch sensor it has been touched or where along the touch sensor the user's finger has been brought in close proximity.

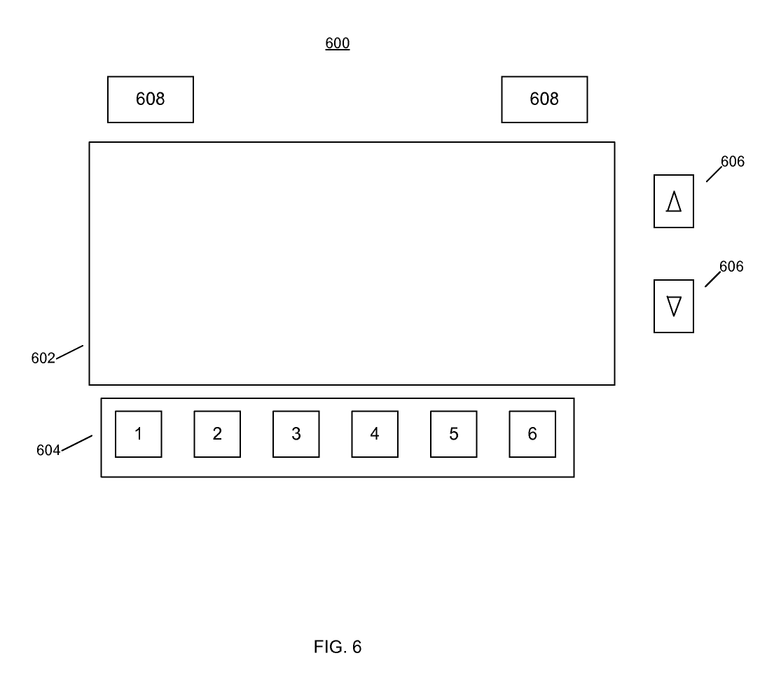

Referring to FIG. 6, an electronic device 600 in a further example is illustrated. Electronic device 600 may be implemented in an automobile dash, for example, where the driver has limited ability to focus on the electronic device controls while driving. Electronic device 600 includes a display screen 602, loudspeakers 608, and a plurality of touch sensors 604 and touch sensors 606. Touch sensors 604 and touch sensors 606 may be configured to perform a variety of user interface actions associated with the electronic device 600 application. For example, where electronic device 600 is implemented in an automobile application, touch sensors 604 and 606 may represent a user interface for the automobile entertainment system such as a radio or compact disc player. Speakers 608 operate as an audio feedback device and display screen 602 operates as a visual feedback device responsive to the driver bringing his finger or hand within close proximity to one of the touch sensors 604 or touch sensors 606. For example, the visual feedback may be the touch sensor function displayed in large text on display screen 602. Alternatively, the touch sensor function may be output through speakers 608 using speech. In a further example, display screen 602 is a touch sensor display screen formed by an array of touch sensors whereby the user touches the display to interact with electronic device 600. In this example, when the user brings his finger to hover over the display screen, feedback is provided to the user via the display screen 602 or speakers 608. For example, a graphic displayed on the display screen may be highlighted in some manner.

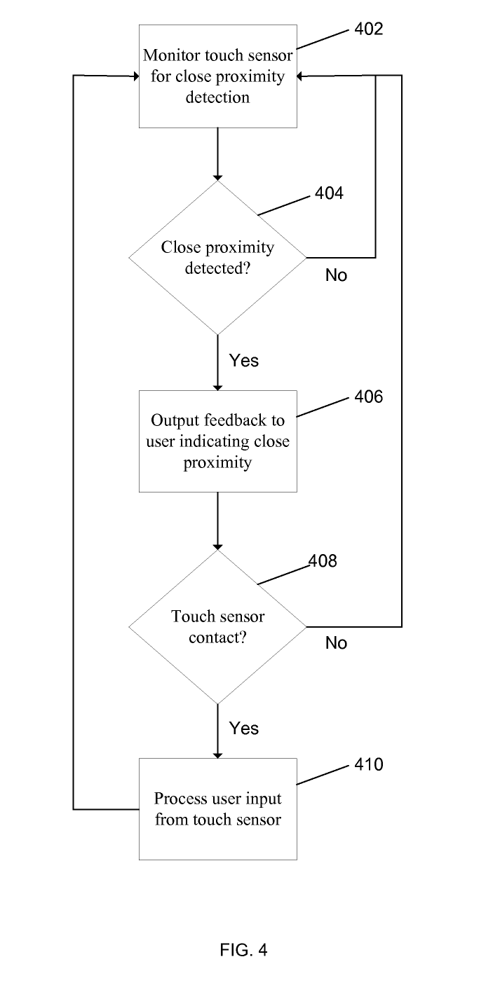

FIG. 4 is a flowchart illustrating processing of an electronic device user interface interaction in an example. At block 402, a touch sensor is monitored for close proximity detection. At decision block 404, a detection is made whether a user's finger or hand has been brought within a close proximity to the touch sensor, but not contacted the touch sensor. If no at decision block 404, the process returns to block 402 and the touch sensor continues to be monitored. If yes at decision block 404, at block 406 the electronic device outputs feedback to the user indicating that the touch sensor has detected the user's finger or hand in close proximity. As described above, such user feedback may take a variety of forms, either visual or non-visual. At decision block 408, it is determined whether the touch sensor has been touched by the user. If no, the process returns to block 402. If yes at decision block 408, at block 410 the touch sensor processes the user input received from the touch sensor. For example, the user input may include any type of input or control associated with the use of touch sensors, including single tap inputs, double tap inputs, or a scrolling/sliding motion input. Following block 410, the process returns to block 402.

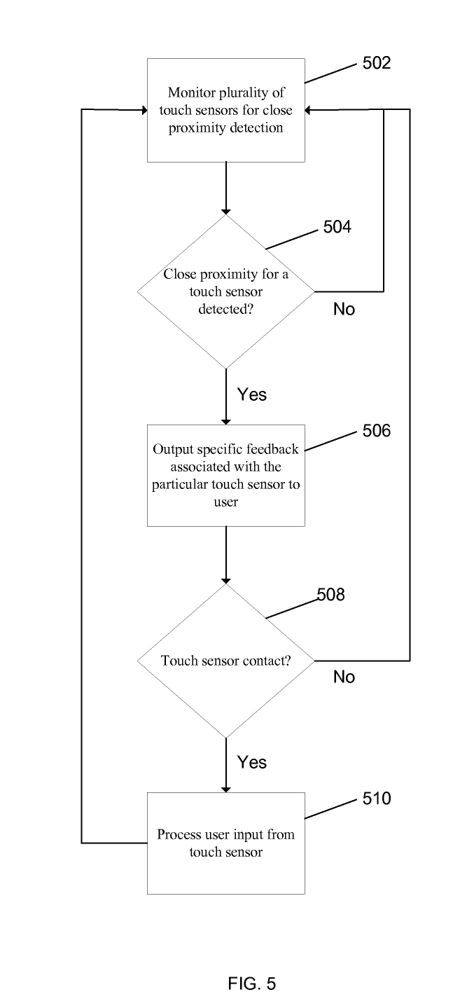

FIG. 5 is a flowchart illustrating example processing of a user interface interaction in a further example. An electronic device includes two or more touch sensors. At block 502, the plurality of touch sensors are monitored for close proximity detection. At decision block 504, a detection is made whether a user's finger or hand has been brought within a close proximity to a particular touch sensor, but not contacted the touch sensor. If no at decision block 504, the process returns to block 502 and the plurality of touch sensors continue to be monitored. If yes at decision block 504, at block 506 the electronic device outputs a particular feedback associated with the touch sensor for which proximity has been detected, indicating to the user that the particular touch sensor has detected the user's finger or hand in close proximity.

Each touch sensor of the plurality of touch sensors provides a different user feedback. The different user feedback provided by each touch sensor enables the user to distinguish between different touch sensors prior to contacting them to decide whether the touch sensor is the correct desired touch sensor to perform a desired action associated with the touch sensor. If yes, then the user touches the contact sensor to perform the desired action. At decision block 508, it is determined whether the touch sensor has been touched by the user. If no, indicating that the user has not identified the correct touch sensor, the process returns to block 502 and the user may hover his finger in close proximity to a different touch sensor. If yes at decision block 508, at block 510 the touch sensor processes the user input received from the touch sensor as described above. Following block 510, the process returns to block 502.

The various examples described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. For example, the methods and systems described herein may be applied to other body worn devices in addition to headsets. Furthermore, the functionality associated with any blocks described above may be centralized or distributed. It is also understood that one or more blocks of the headset may be performed by hardware, firmware or software, or some combinations thereof. Such modifications and changes do not depart from the true spirit and scope of the present invention that is set forth in the following claims.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1. A headset comprising:
a microphone;
a speaker;
a proximity sensing touch sensor for detecting a close proximity status whereby a user's finger is within a proximity to the proximity sensing touch sensor and for detecting a subsequent touch status whereby the user's finger is in contact with the proximity sensing touch sensor;
a user feedback mechanism associated with the proximity sensing touch sensor; and
a processor, wherein the processor responsively processes a close proximity status detection by outputting a feedback to the user with the user feedback mechanism and processes the subsequent touch status by performing a desired user action.

2. The headset of claim 1, wherein the user feedback mechanism comprises one or more selected from the following group: a vibrate motor, an audible sound output through the speaker, and a light source.

3. The headset of claim 1, wherein the proximity sensing touch sensor comprises a capacitive sensor.

4. The headset of claim 1, wherein the proximity sensing touch sensor is associated with a headset control operation comprising one or more selected from the following group: volume control, power control, call answer, call terminate, item select, next item, and previous item.

5. The headset of claim 1, wherein the user feedback mechanism comprises a heads-up display.

6. An apparatus comprising:
a plurality of proximity sensing touch sensors for detecting a plurality of close proximity statuses, wherein each close proximity status detected is associated with a particular proximity sensing touch sensor;
a plurality of user feedback mechanisms, wherein each user feedback mechanism is associated with a particular proximity sensing touch sensor; and
a processor, wherein the processor responsively processes a detected close proximity status by outputting a feedback to the user with the particular user feedback mechanism associated with the particular proximity sensing touch sensor.

7. The apparatus of claim 6, wherein the plurality of user feedback mechanisms comprise one or more selected from the following group: a vibrate motor, an audible sound, and a light source.

8. The apparatus of claim 6, wherein the plurality of user feedback mechanisms comprise a vibrate motor having a plurality of vibrate patterns.

9. The apparatus of claim 6, wherein the plurality of proximity sensing touch sensors comprises a plurality of capacitive sensors.

10. The apparatus of claim 6, wherein the plurality of user feedback mechanisms comprise a plurality of distinct audio tones or audio patterns.

11. The apparatus of claim 6, wherein the plurality of user feedback mechanisms comprise a plurality of graphics displayed on a display screen.

12. An apparatus comprising:
a plurality of proximity sensing touch sensors for detecting a plurality of close proximity statuses, wherein each close proximity status detected is associated with a particular proximity sensing touch sensor;
a plurality of non-visual user feedback mechanisms, wherein each non-visual user feedback mechanism is associated with a particular proximity sensing touch sensor; and
a processor, wherein the processor responsively processes a detected close proximity status by outputting a feedback to the user with the particular non-visual user feedback mechanism associated with the particular proximity sensing touch sensor, thereby enabling the user to determine non-visually which proximity sensing touch sensor the user is in close proximity to.

13. The apparatus of claim 12, wherein the plurality of non-visual user feedback mechanisms comprise a vibrate motor or an audible sound.

14. The apparatus of claim 12, wherein the plurality of non-visual user feedback mechanisms comprise a vibrate motor having a plurality of vibrate patterns.

15. The apparatus of claim 12, wherein the plurality of proximity sensing touch sensors comprises a plurality of capacitive sensors.

16. The apparatus of claim 12, wherein the plurality of non-visual user feedback mechanisms comprise a plurality of distinct audio tones or audio patterns.

17. A method for interfacing with an electronic device comprising:
providing a plurality of proximity sensing touch sensors on an electronic device;
providing a plurality of user feedback mechanisms for the electronic device;
associating a particular user feedback mechanism with a particular proximity sensing touch sensor;
detecting a close proximity status to a particular proximity sensing touch sensor; and
outputting the particular user feedback mechanism associated with the particular proximity sensing touch sensor for which a close proximity status is detected.

18. The method of claim 17, further comprising receiving a user touch of a proximity sensing touch sensor subsequent to outputting the particular user feedback mechanism associated with the particular proximity sensing touch sensor for which a close proximity status is detected.

19. The method of claim 17, wherein the plurality of user feedback mechanisms comprise one or more selected from the following group: a vibrate motor, an audible sound, and a light source.

20. The method of claim 17, wherein the plurality of user feedback mechanisms comprise a vibrate motor having a plurality of vibrate patterns.

21. The method of claim 17, wherein the plurality of proximity sensing touch sensors comprises a plurality of capacitive sensors.

22. The method of claim 17, wherein the plurality of user feedback mechanisms comprise a plurality of distinct audio tones or audio patterns.

23. A system comprising:
a plurality of proximity sensing means for detecting a plurality of close proximity statuses, wherein each close proximity status detected is associated with a particular proximity sensing means;
a plurality of user feedback means for outputting a user feedback, wherein each user feedback means is associated with a particular proximity sensing means; and
a processing means for outputting a feedback to the user with the particular user feedback means associated with the particular proximity sensing means for which a close proximity status is detected.

24. The system of claim 23, wherein the plurality of proximity sensing means are disposed on a first electronic device and the plurality of user feedback means are disposed on a second electronic device.
